(19) United States
(12) Patent Application Publication
(10) Pub. No.: US 2008/0282059 A1
(43) Pub. Date: Nov. 13, 2008

(54) METHOD AND APPARATUS FOR DETERMINING MEMBERSHIP IN A SET OF ITEMS IN A COMPUTER SYSTEM

(76) Inventors: Kattamuri Ekanadham, Mohegan Lake, NY (US); Il Park, White Plains, NY (US); Pratap Chandra Pattnaik, Ossining, NY (US); Xiaowei Shen, Hopewell Junction, NY (US)

Correspondence Address: IBM CORPORATION, T.J. WATSON RESEARCH CENTER, P.O. BOX 218, YORKTOWN HEIGHTS, NY, 10598, US

(21) Appl. No.: 11/746,269

(22) Filed: May 9, 2007

(51) Int. Cl. G06F 9/30

(52) U.S. Cl. 712/9; 712/E09.001

(57) ABSTRACT

A method and apparatus for maintaining membership in a set of items to be used in a predetermined manner in a computer system. A representation of each member of the set is mapped into a number of components of a primary and secondary vector when a member is added to the set. Periodically, the primary vector is changed to the secondary vector and the secondary vector to the primary vector. When members of the set are deleted, the components of the secondary vector are changed to indicate deletion of these members after the primary vector is changed to the secondary vector. Finally, membership in the set is determined by examining the components in the primary vector, and the members in the set of items are then used in a predetermined manner in the computer system. More specifically, in a sample embodiment of the present invention, membership in the set would determine if data is to be stored or removed from cache memory in a computer system. This invention, for example, provides a low cost and high performance mechanism to phase out aging membership information in a prefeteching mechanism for caching data or instructions in a computer system.

### BACKGROUND

More generally, this invention is a method and apparatus for maintaining information about membership in a set, wherein membership in the set determines how items in the set are to be handled in a computer system. More specifically, an embodiment of the present invention relates to a method and apparatus for storing and removing data from cache memory in a computer system according to the data's membership in a set.

A special very high-speed memory is sometimes used to increase the speed of processing within a data processing system by making current programs and data available to a processor (“CPU”) at a rapid rate. Such a high-speed memory is known as a cache and is sometimes employed in large computer systems to compensate for the speed differential between main memory access time and processor logic. Processor logic is usually faster than main memory access time with a result that processing speed is mostly limited by the speed of main memory. A technique used to compensate for the mismatch in operating speeds is to employ one or more extremely fast, small memory arrays between the CPU and main memory whose access time is close to processor logic propagation delays. It is used to store segments of programs currently being executed in the CPU and temporary data frequently needed in the present calculations. By making programs (instructions) and data available at a rapid rate, it is possible to increase the performance rate of the processor.

If the active portions of the program and data are placed in a fast small memory such as a cache, the average memory access time can be reduced, thus reducing the total execution time of the program. The cache memory access time is less than the access time of main memory often by a factor of five to ten. The cache is the fastest component in the memory hierarchy and approaches the speed of CPU components.

The fundamental idea of cache organization is that by keeping the most frequently accessed instructions and data in one or more fast cache memory arrays, the average memory access time will approach the access time of the cache. Although the cache is only a small fraction of the size of main memory, a large fraction of memory requests will be found in the fast cache memory because of the locality of reference property of programs.

The basic operation of the cache is as follows. When the CPU needs to access memory, the cache is examined. If the word is found in the cache, it is read from the fast memory. If the word addressed by the CPU is not found in the cache, the main memory is accessed to read the word. A block of words containing the one just accessed is then transferred (prefetched) from main memory to cache memory. In this manner, some data is transferred to cache so that future references to memory find the required words in the fast cache memory.

Prefetching techniques are often implemented to try to supply memory data to the cache ahead of time to reduce latency. Ideally, a program would prefetch data and instructions far enough in advance that a copy of the memory data would always be in the cache when it was needed by the processor.

Data prefetching is a promising way of bridging the gap between faster pipeline and slower cache hierarchy. Most prefetch engines, that are in vogue today, try to detect repeated patterns among memory references. According to the detected patterns, they speculatively bring possible-future references into caches closer to the pipeline. Different prefetch engines use different methods for detecting reference patterns and speculating upon which references to prefetch. A prefetch engine often needs to accumulate historical information observed from the reference stream and base its prediction upon it. However, it is also important to periodically age-out stale information in an efficient manner.

A common paradigm in pre-fetching engines, which are in vogue today, is to have a learning phase and a tracking phase. During a learning phase, a prefetch engine detects a possible pattern exhibited by a sequence of memory accesses. Having detected, the prefetch engine switches to a tracking phase to track the progress of the pattern and issue prefetches as long as the pattern continues. For example, to detect strided references, a state machine is instituted so that it remembers the base address and the constant stride between two references. Each reference made thereafter is compared to see if the reference forms the next term in the strided sequence. If so, the state advances remembering the number of terms identified in the sequence. After a sequence of sufficient length is recognized, the state machine is disbanded, and the tracking phase is started to issue prefetches for future reference items in the sequence, ahead of time.

In general, the learning phase involves some finite tables to remember information in a local time window and possibly some associative searches to determine whether a suitable match has occurred. Scarcity of hardware resources often limits the table size and the type of searches, thereby forcing the stored information to be discarded after some time and re-learn the same information when the pattern re-appears at a later time during execution. Prefetching starts paying dividends only during the tracking phase that follows each learning phase.

Furthermore, it is not necessary to go through an entire re-learning phase before triggering the next tracking phase. It is sufficient to remember the occurrence of the first term of a pattern. In the above example, let's suppose that there is a strided sequence of references, “a, a+d, a+2d, . . . ”. If we remember the address “a” and recognize the next occurrence of “a”, then we can trigger the tracking phase much quickly without having to go through an elaborate re-learning phase. However, program behavior often changes and the same pattern may not repeat at the term that is remembered???. Hence, there is a need for a simple mechanism to phase-out old information over a period of time so that either the information will be re-confirmed or new information can be entered the next time when going through a re-learning phase.

There is, therefore, a need to provide for a low cost and high performance mechanism to phase out aging membership information in a prefeteching mechanism, for caching data or instructions.

More generally, there is a need to provide for a low cost and high performance mechanism to phase out aging membership information for items in a computer system to determine the handling of the items.

### SUMMARY OF THE INVENTION

Accordingly, it is an object of this invention to provide a low cost and high performance mechanism to delete aging information in a set of items, such as data or instructions.

It is a more specific object of this invention to age out stale information in a membership engine of a data prefetcher in cache management systems, so that the right data or instructions are in the cache when it is needed for further processing or execution.

This invention provides a mechanism to accomplish easy aging in set of items to be used by a computer system by maintaining a primary and a secondary vector, which preferably have the same size and interface. An item is declared to be a member of a set when a representation of the item is found in the primary vector. When an item is inserted in a set, its representation is entered in both the primary and secondary vectors. Periodically, the two vectors are switched, that is making the primary vector become the secondary vector, and making the secondary vector become the primary vector. Then, at least some of the components of the new secondary bit vector are set to zeroes. Membership in the set is determined by examining the components in the primary vector, and the items in the set are then used in a predetermined manner.

In a more specific embodiment of this invention the set of items to be used by the computer system represent addresses of frequently used data or instructions to be stored in a cache memory. When there is a cache line miss for data or instructions, the primary vector is examined to see if the entry corresponding to the data or instructions is in the primary vector. If the entry corresponding to the data or instructions is found in the primary vector, then the corresponding data or instructions are prefetched into the cache.

### BRIEF DESCRIPTIONS OF THE DRAWINGS

FIG. 1, schematically illustrates a data processing system which embodies the invention. Shown are the processor core, the cache system 130, and the main memory.

FIG. 2 depicts in greater detail the four main components of the data processing system designed to accomplish data prefetching: the Load Store Unit, the Membership Engine (ME), Detection Engine (DE) and timer.

FIG. 3 schematically illustrates an algorithm for updating the primary and secondary vectors in accordance with an embodiment of the invention.

FIG. 4 illustrates a timer mechanism which periodically sends a time out signal to the time out action module in accordance with an embodiment of the invention.

FIG. 5 illustrates one example of how the primary and secondary vectors are maintained, where the primary and secondary vectors are switched at every cycle P as measured by timer 400.

### DETAILED DESCRIPTION OF THE INVENTION

It should be noted that the embodiment described below is only one example of usage of the invented apparatus, and does not constrain the generality of the claims in any manner.

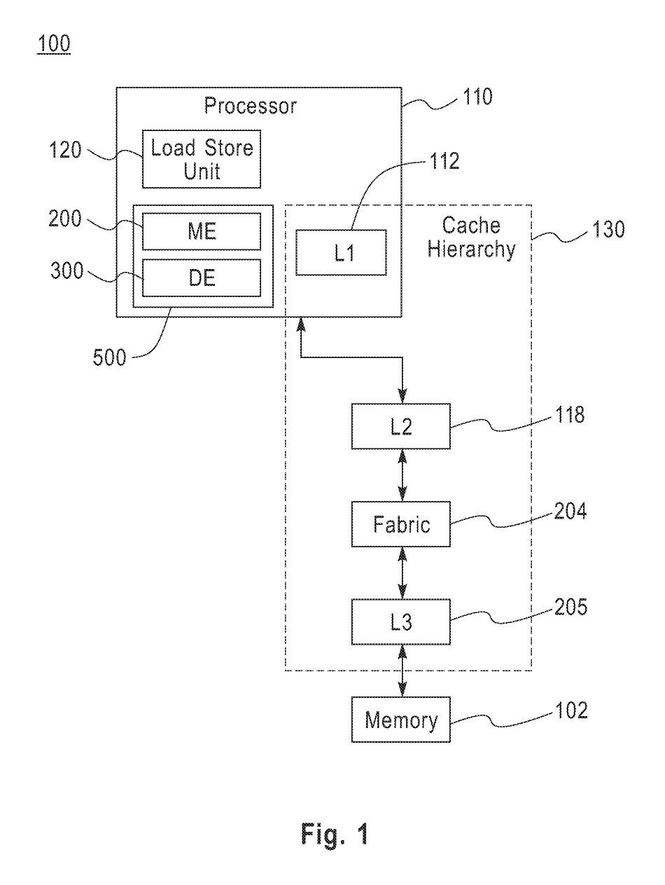

Referring now to FIG. 1, a data processing system which advantageously embodies the present invention will be described. For the sake of illustration processor system 100 includes only a single processor, but may include multiple processors. In the embodiment hereinafter described, processor core 110 has an embedded L1 (primary or first level) cache 112, a Load Store Unit 120, and a Prefetch Engine 500, which includes a Membership Engine (ME) 200 and a Detection Engine (DE) 300 to be described below. L2 cache 118 is coupled to fabric 204, which may embody a bus system for enabling other processor cores, or other types of devices typically coupled to a data processing system. Coupled to fabric 204 is L3 (level three) cache 205, which is then coupled to system memory 102. L3 cache 205 and memory 102 may be shared by processor core 110 with other devices coupled to fabric 204. As a result, system 100, in this example, embodies a three-level cache system 130 for alleviating latency problems. L3 cache 205 and the main system memory 102 may be partitioned.

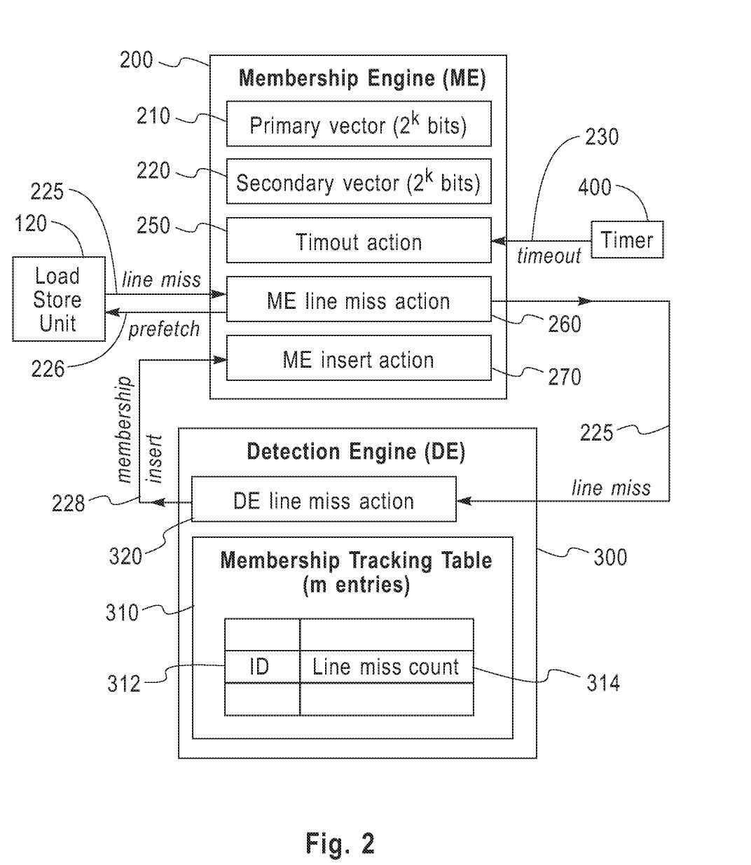

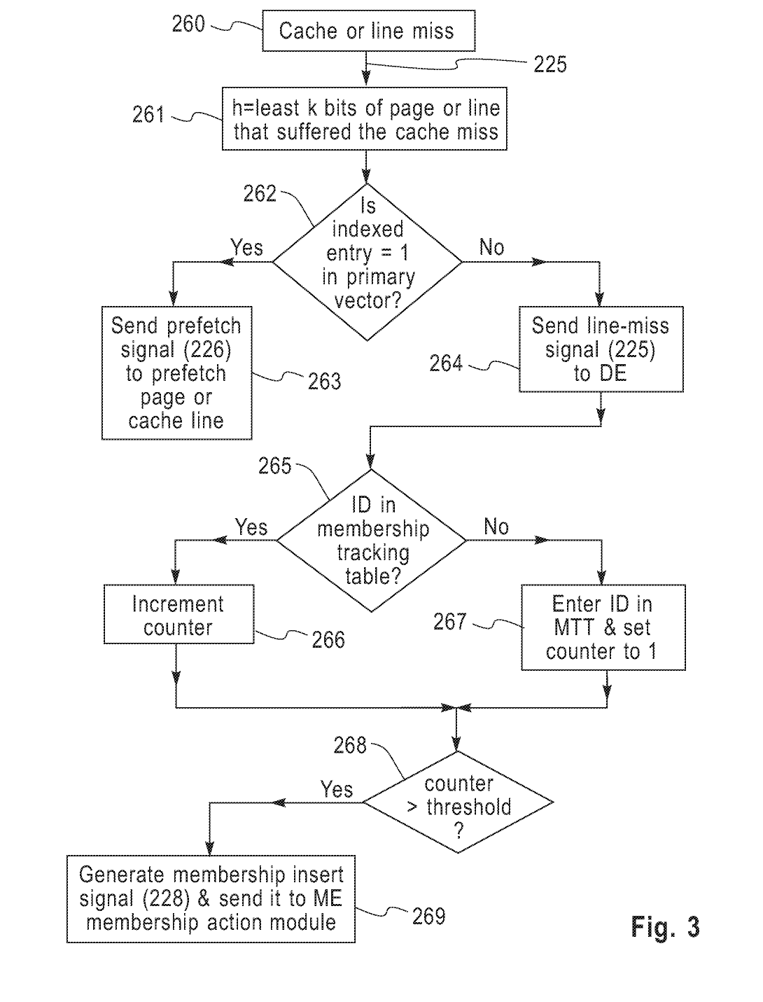

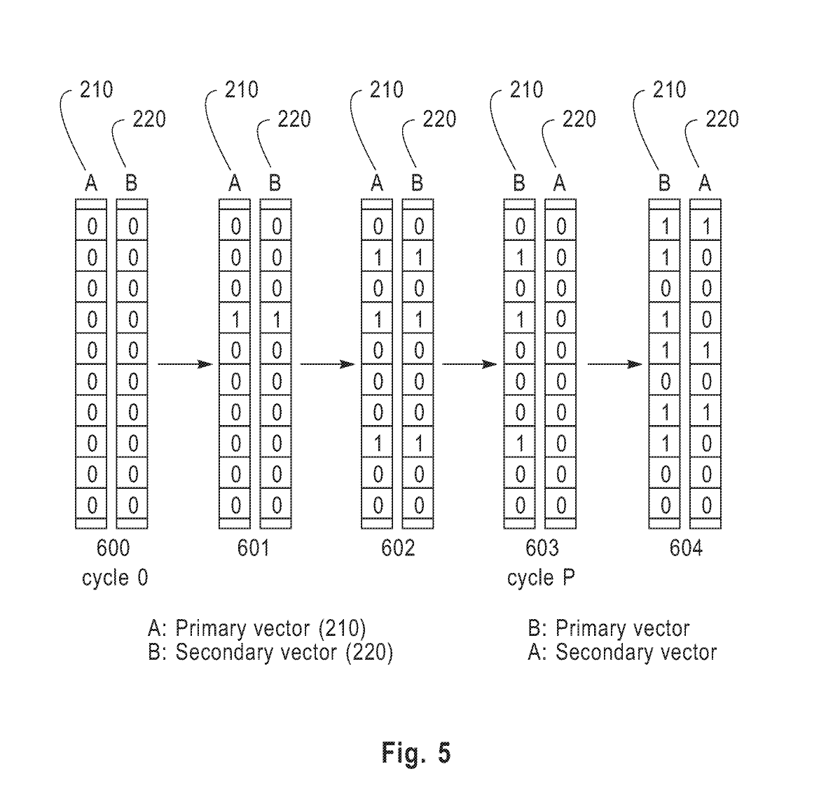

As an example, FIG. 2 depicts in greater detail the four main components of the data processing system designed to accomplish data prefetching: Load Store Unit 120, Membership Engine (ME) 200, Detection Engine (DE) 300 and timer 400. The Load Store Unit 120 performs memory accesses and communicates line misses suffered by the cache. Most commercial processors have a Load Store Unit (LSU) which is very well known in the art. The LSU also receives prefetch signals 226 initiated by the Membership Engine and initiates the corresponding prefetches into the cache. The Membership Engine is provided to compactly represent large sets providing efficient insertion, membership, and aging facilities. Referring to FIGS. 2 and 5, the Membership Engine maintains a primary bit vector 210 and a secondary bit vector 220 and contains three action modules (250, 260 and 270) described below. The vectors, whose components may represent membership in a class, are also described below. Membership in the class is used, in one embodiment of this invention, to determine which data is to be stored in cache memory in the event of a line miss. The Detection Engine 300 maintains Membership Tracking Table 310, in which each entry contains an ID 312 corresponding to a page or a cache line number and a count 314 of lines missed in the page or of misses of the cache line. When the count exceeds a threshold (See 268 of FIG. 3.), the vectors of the ME are updated as described below. The timer 400 sends a timeout signal after each interval of a predefined size, say P, so that the Membership Engine can also update the primary vector 210 and secondary vector 220 as described below, where both vectors preferably are of identical size and have the same indexing interface. The DE and ME can be implemented, for example, on the processor chip using well known hardware, such as registers or latches.

A cache line miss occurs when the corresponding line is not in the cache and the hardware automatically fetches the line at that time. A prefetch mechanism anticipates future uses of a line by the processor and issues commands to prefetch lines into the cache ahead of time, so that the transfer latency can be masked. As an example, a page is marked as hot, if the number of cache line misses exceeds a predefined threshold. When a page becomes “hot”, a hash of its address will be used to update the vectors in the membership engine as describe below. When the next line miss occurs in the hot page, the update in the vectors will be detected, thereby causing the prefetcher to initiate the transfer of all lines of the hot page into the cache, as shown in steps 262 and 263 of FIG. 3 and as described more fully below. More specifically, referring now to FIGS. 2 and 3, a line miss signal 225 is sent from the LSU to the line miss action module 260 when there is, for example, a cache miss. In FIG. 3, under conditions specified in a predefined algorithm, such as when the number of line misses reaches a threshold, the least significant k bits (h) 261 of the address of the page or cache line that suffered the cache miss will be used to generate an index (primary [h]) into a primary vector of the membership engine. If the indexed entry is one (262), the prefetch signal 226 will be sent to the LSU to prefetch, for example, the page or the line (263). Otherwise, if the indexed entry is 0, the line miss signal 225 is sent to the detection engine to update the DE line miss action module, which in turn updates the membership tracking table 310 shown in FIG. 2. More specifically, when the line miss signal 225 is received by the DE line miss action module 320, then an ID 312 is generated, for example, using a hash function on the address of the page or cache line that suffered the cache miss. Referring to 265 of FIG. 3, if the ID is not already in tracking table 310, then it is entered into table 310 and the line miss count 314 is set to 1. See 267 of FIG. 3. If the ID is already in the table, then the line miss count corresponding to the ID is incremented. See 266 of FIG. 3. Finally, when the count exceeds a threshold (See 268.), the membership insert signal 228 is generated as shown in 269 of FIG. 3. This insert signal then causes the membership engine action module to update the corresponding components in the primary and secondary vectors.

The modules of the ME 200 and the DE 300 can be implemented, for example, in hardware using well known devices such registers and latches on a semiconductor chip.

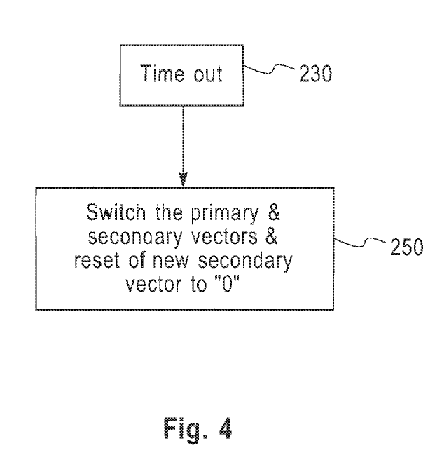

FIG. 5 illustrates one example of how the primary and secondary vectors are maintained, where the primary and secondary vectors are switched at every cycle P as measured by timer 400. The lifetime of membership for an item in this example is cycle 2P. Referring again to FIG. 2, the vectors shown in FIG. 5 are updated when the detection engine line miss action module 320 sends a membership insert signal 228 to the ME membership insert action module 270. See also FIG. 3. That is, the insert signal is sent in response to a line miss signal 225 when the corresponding line or page miss count reaches a predefined threshold. (See 268 of FIG. 3.) The line miss signal 225 is passed through the ME line miss action module 260 when a representation of the missed page or line is not found in the primary vector 210. The primary and secondary vectors are indexed by hashing the least significant k bits of the address of, for example, the page or cache line that suffered the cache miss. As shown in 601 of FIG. 5, the indexed entry of both the primary vector A and secondary vector B are set to 1, where initially, as shown in 600, all the components of the two vectors were set to zero. 602 of FIG. 5 illustrates the response to two additional insertion signals where the corresponding indexed entries are set to 1, thus showing a total of three entries set to 1 in both vectors. Referring now to FIG. 4, timer 400 periodically sends a time out signal 230 to time out action module 250. As shown in 603 of FIG. 5, upon reception of this time out signal, the primary 210 and secondary vectors 220 are switched, so that the primary vector becomes the secondary vector and the secondary vector becomes the primary vector. Then, all the bits of the new secondary vector are set to 0 as shown in 603. 604 of FIG. 5 shows the response of the ME insert action module 270 to three additional insert signals occurring after the first timeout signal 230. Notice that the primary vector has indications of cache misses over 2P cycles, while the secondary vector only remembers cache misses over P cycles.

In an alternative embodiment, FIG. 6 illustrates how a multi-phase membership system records membership of an address. The system comprises a primary representation vector 210 prime, a secondary representation vector 220 prime, and at least one circuit module that implement one or more hash functions, such as H sub 1 through H sub 4. Each hash function maps an address to an index that can be used to index the primary representation vector and the secondary representation vector. To record a given address, the multi-phase membership system sets each corresponding bit (indexed by each hash function) to 1 in both the primary representation vector and the secondary representation vector.

It should be appreciated by those skilled in the art that although four hash function modules are depicted, the multi-phase membership system can comprise any number of hash function modules as long as at least one hash function module is included. It should also be appreciated by those skilled in the art that the multi-phase membership system has no specific requirements for the hash functions implemented by the hash function modules, although different hash functions may result in different performance. An exemplary hash function simply maps an address x to the remainder of x divided by M, wherein M is the number of bits in each representation vector.

Also, in the alternative, FIG. 7 illustrates how a multi-phase membership system checks membership of an address. To check a given address, the multi-phase membership system checks each corresponding bit (indexed by each hash function) in the primary representation vector 210 prime. The membership of the address is confirmed only if all the corresponding bits in the primary representation vector have been set to 1. It should be noted that the secondary representation vector is not consulted in the membership checking process.

As stated above, according to an embodiment of the present disclosure, the primary representation vector and the secondary representation vector need to periodically switch their roles. When this happens, the original secondary representation vector becomes the new primary representation vector, and the original primary representation vector becomes the new secondary representation vector. Meanwhile, each bit in the new secondary representation vector is cleared to 0.

A detection engine is used to detect a pattern among memory references. As described above, a detection engine consists of two architectural components, a storage component 310 and a detection algorithm 320. The storage is a table-like structure, which may be indexed by reference addresses. Each entry should have enough machinery to accomplish what the detection algorithm needs to do. The detection engine described above inserts members in a set on the basis of a threshold number of line of cache misses. An example alternative algorithm used in the DE 300 is where the detection engine may track references to a page and label a page as “hot” if the number of such references exceeds a threshold. In this example, each entry in the table needs to have a counter to keep the information about how many times the relevant page is accessed. The detection algorithm is simply comparing a threshold value with the counter value stored in the table. The threshold value can be a predefined constant or a dynamically adjustable value. When the threshold is reached, the membership insert signal 228 is generated thereby causing membership engine updates as described above.

1. A method of maintaining membership in a set of items to be used in a predetermined manner in a computer system, said method comprising:
mapping a representation of each member of said set into at least one of a plurality of components of a primary and secondary vector when a member is added to said set;
periodically changing said primary vector to said secondary vector and said secondary vector to said primary vector;
changing components of said secondary vector to indicate deletion of at least some members in the set represented by said secondary vector after a primary vector is changed to said secondary vector; and
determining membership in said set by examining the components in said primary vector, wherein said set of items are used in said predetermined manner in said computer system.

2. A method as recited in claim 1 wherein said components of said secondary vector are changed to indicate that all of said members have been deleted from the set represented by said secondary vector after a primary vector is changed to said secondary vector.

3. A method as recited in claim 1, wherein said items comprised data to be stored in said computer system.

4. A method of maintaining membership in a set of items to be stored in a cache memory of a computer system, said method comprising:
mapping a representation of each member of said set into at least one of a plurality of components of a primary and secondary vector each time a member is added to said set;
periodically changing said primary vector to said secondary vector and said secondary vector to said primary vector;
changing components of said secondary vector to indicate deletion of at least some members in the set represented by said secondary vector after said primary vector is changed to said secondary vector;
determining membership in said set by examining at least some of said components in said primary vector; and
storing in said cache data or instructions corresponding to any item which is determined to be a member of said set when there is a cache miss for said data or instructions.

5. A method as recited in claim 4, wherein said primary vector and said secondary vector have the same number of components.

6. A method as recited in claim 4 wherein said set of items is a set of pages, where each page is accessed more than a minimum threshold number of times during a time interval.

7. A method as recited in claim 4 wherein said set of items is a set of lines of data, where each line suffers a cache miss more than a minimum threshold number of times.

8. A method as recited in claim 4, wherein said set of items is a set of pages of data, where each page suffers a cache miss more than a minimum threshold number of times.

9. An apparatus for maintaining membership in a set of items to be used in a computer system, said method comprising:
an membership engine for mapping a representation of each member of said set into at least one of a plurality of components of a primary and secondary vector when a member is added to said set;
a timer and time out action module for periodically changing said primary vector to said secondary vector and said secondary vector to said primary vector and for changing all components of said secondary vector to indicate that there are no members in the set represented by said secondary vector after each time a primary vector is changed to said secondary vector; and
said membership engine also for determining membership in said set by examining the components in said primary vector, wherein said set of items are used in said predetermined manner in said computer system.

10. An apparatus as recited in claim 9, wherein said primary vector and said secondary vector have the same number of components.
An apparatus as recited in claim 9, wherein said set of items is a set of pages, where each page is accessed more than a minimum threshold number of times during a time interval.
An apparatus as recited in claim 9, wherein said set of items is a set of lines of data, where each line suffers a cache miss more than a minimum threshold number of times.
An apparatus as recited in claim 9, wherein said set of items is a set of pages of data, where each page suffers a cache miss more than a minimum threshold number of times.
